(19) United States
(12) Patent Application Publication
(10) Pub. No.: US 2022/0335506 A1
(43) Pub. Date: Oct. 20, 2022

(54) SYSTEM, METHOD AND PROGRAMMED PRODUCT FOR LOCATION BASED AGGREGATION OF PURCHASER DEMAND AND REVERSE BIDDING BY SELLERS IN RESPONSE TO THE AGGREGATED DEMAND

(71) Applicant: Cliquebuys LLC, Wallingford, PA (US)

(72) Inventors: Suman A. Patil, Wallingford, PA (US); Amit C. Patil, Wallingford, PA (US); Channa Mydur, Wallingford, PA (US)

(21) Appl. No.: 17/719,846

(22) Filed: Apr. 13, 2022

Related U.S. Application Data
(60) Provisional application No. 63/176,074, filed on Apr. 16, 2021.

(51) Int. Cl. G06Q 30/06; G06Q 30/08; G06Q 30/02

(52) U.S. Cl. CPC G06Q 30/0639; G06Q 30/0605; G06Q 30/0611; G06Q 30/08; G06Q 30/0205

(57) ABSTRACT

A computer-implemented system and method for aggregating purchaser demand for products or services in a common geographical area within a common time period and providing for a reverse auction for sellers to bid on the aggregated demand. A computer system is provided as a server for seller computer systems and purchaser computer systems so as to provide algorithmic determination of demand aggregates based on requests-for-quotes (RFQs) received from a plurality of purchaser computer systems and a reverse auction platform allowing a plurality of seller computer systems associated with sellers of products or services within the geographical area and time period associated with the demand aggregates to place bids on the demand aggregates.

### CROSS-REFERENCE TO RELATED APPLICATION

The present patent claims priority to and the benefit of U.S. Provisional Application No. 63/176,074, filed Apr. 16, 2021 and entitled METHOD AND APPARATUS TO ESTABLISH AN e-COMMERCE SYSTEM THAT CAN FACILITATE LOCATION BASED AGGREGATION OF PURCHASER DEMAND & ENABLE SELLERS TO BID FOR THE CONSOLIDATED BUSINESS OPPORTUNITY OF THE DEMAND-AGGREGATE VIA AN AUCTION PROCESS, the contents of which are incorporated herein by reference in their entirety.

### FIELD

The present invention relates generally to automated systems and methods for coordinating electronic transactions between purchasers and sellers of products or services.

### BACKGROUND

In the conventional shopping environment individual customers, herein afterwards referred to as “purchasers”, make their purchase decision by comparing specifications and price of product(s)/service(s) presented by the retailer/manufacturer/provider, herein afterwards referred to as “seller.” For example, in a conventional environment, this comparison may occur on multiple internet platforms and/or other methods and potential purchase by a purchaser may occur on the seller's e-commerce platform and/or in store.

Once a purchaser has made the decision on which product(s)/service(s) to purchase, the purchase/sale transaction is executed at a seller specified, usually non-negotiable price. If the purchaser(s) are seeking to obtain the best value for their money then, in order to obtain a better/lower price, the purchasers might search for discount coupon codes and/or search for deals or wait for sale-day/deal-day (Ex. Black Friday) to execute the purchase transaction.

The purchasing power, in terms of dollar value, of an individual purchaser is small and often does not have enough leverage to motivate the seller to compete for the individual's business by providing a discounted/better price.

The seller advertises their product(s)/service(s) on numerous online web-sites and/or other media in order to generate leads. A confluence of consumer demand and price-point of the offered product(s)/service(s) will trigger conversion of a (usually small) percentage of those leads into actual sales.

The seller lists their product(s)/service(s) at an online and/or brick & mortar retail store(s) in order to execute the sales transaction & deliver to the end-consumer/Purchaser. When this occurs a (usually significant) portion of the mark-up on the product(s)/service(s) will be shared with the store, directly impacting the OEM/primary distributor/seller's bottom-line.

Since it is difficult to accurately predict consumer demand by specific geographical area/boundaries, the seller ends up stocking on either too much inventory at a location, which negatively impacts cash flow by locking up capital, or less inventory than actual demand resulting in lost sales opportunities, negatively impacting revenue.

Technological challenges exist in matching groups of purchasers with groups of sellers that allows for matching of such groups with one another, to maximize cash flow and/or inventory for sellers while at the same time providing purchasers with enhanced purchasing power. Accordingly, there is a need for a technological solution that provides a computer-implemented arrangement between seller and purchaser computer systems that addresses this technological challenge.

### SUMMARY

An object of the present invention is to provide a computer-implemented system and method that geo-tags purchasers and sellers and allows for gathering of data from multiple seller computer systems and multiple purchaser computer systems so that groups of purchasers can aggregate their demand for particular products and/or services within a common geo-location and within a common time period and multiple sellers can place bids on a reverse auction in response to the aggregated demand within that geo-location and time period.

Another object of the present invention is to provide a computer-implemented exchange that matches data received from multiple purchaser computer systems with data received from multiple seller computer systems so that an aggregated demand for particular products and/or services within a common geo-location and within a common time period can be met by one or more sellers that bid on the opportunity to meet the aggregated demand through a reverse auction conducted at the computer-implemented exchange.

A method according to an exemplary embodiment of the present invention comprises: (A) accessing, by one or more computers, one or more electronic databases stored on one or more computer-readable media, comprising: (1) purchaser account information for a plurality of purchaser accounts corresponding to a plurality of purchasers of products or services; (2) request-for-quote information for a plurality of request-for-quotes each made by a corresponding purchaser among the plurality of purchasers for purchase of a corresponding quantity of corresponding products or services within a corresponding geographical area within a corresponding time period; (3) demand aggregate information for a plurality of demand aggregates, each demand aggregate corresponding to two or more request-for-quotes made by corresponding two or more purchasers from among the plurality of purchasers for the same products or services within a common geographical area within a common corresponding time period, each demand aggregate further corresponding to a total quantity of the corresponding common products or services; (4) seller account information for a plurality of seller accounts corresponding to a plurality of sellers of products or services; and (5) reverse auction information for a plurality of reverse auctions each comprising at least one reverse bid made by at least one of the plurality of sellers in response to at least one of the plurality of demand aggregates; (B) receiving, by the one or more computers, from a first purchaser computer system, a first request-for-quote corresponding to first products or services that a first purchaser has an intent to at least one of purchase, consume or take delivery of at a first geographical location at a first time; (C) determining, by the one or more computers, whether the first request-for-quote corresponds to an established demand aggregate among the plurality of demand aggregates, the step of determining comprising: (1) comparing, by the one or more computers, the first products or services, the first geographical location and the first time to the plurality of demand aggregates to determine whether at least one demand aggregate among the plurality of demand aggregates is a matching demand aggregate corresponding to products or services that match the first products or services, a geographical area in which the first geographical location is included, and a time period within which the first time is included; (2) upon the condition it is determined that at least one demand aggregate among the plurality of demand aggregates is a matching demand aggregate, identifying, by the one or more computers, at least one demand aggregate as the established demand aggregate; and (3) upon the condition it is not determined that at least one demand aggregate among the plurality of demand aggregates is a matching demand aggregate, determining, by the one or more computers, that the first request-for-quote does not correspond to an established demand aggregate among the plurality of demand aggregates with corresponding products or services that match the first products or services, a geographical area in which the first geographical location is included, and a time period within which the first time is included; (D) upon the condition it is determined in step (C) that the first request-for-quote does not correspond to an established demand aggregate among the plurality of demand aggregates, generating, by the one or more computers, a first demand aggregate as a new demand aggregate corresponding to the first request-for-quote, the step of generating comprising: (1) receiving, by the one or more computers, from at least a second purchaser computer system, at least a second request-for-quote corresponding to the first products or services that at least a second purchaser has an interest in purchasing at a second geographical location within the first period of time; (2) determining, by the one or more computers, a first geographical area corresponding to the first demand aggregate based on the first geographical location and the second geographical location; (3) adding, by the one or more computers, the at least a second request-for-quote to the first demand aggregate; and (4) generating, by the one or more computers, a first reverse auction as a new reverse auction for satisfaction of the first demand aggregate comprising the first request-for-quote and the at least a second request-for-quote; (E) upon the condition it is determined in step (C) that the first request-for-quote does correspond to an established demand aggregate among the plurality of demand aggregates, adding, by the one or more computers, the first request-for-quote to the established demand aggregate; (F) receiving, by the one or more computers, from a first seller computer system, a first seller bid in the first reverse auction or an established reverse auction corresponding to the established demand aggregate, the first seller bid further corresponding to a first seller for sale of the first products or services; (G) analyzing, by the one or more computers, whether the first seller bid is a winning bid, the step of analyzing comprising: (1) determining, by the one or more computers, whether a time period for the first reverse auction or an established reverse auction among the plurality of reverse auctions corresponding to the established demand aggregate has ended; (2) comparing, by the one or more computers, the first seller bid to other bids within the first reverse auction or to other bids within the established reverse auction to determine whether the first seller bid is a lowest bid; (3) upon the condition it is determined the time period for the first reverse auction or the established reverse auction has ended and the first bid is determined to be the lowest bid, determining, by the one or more computers, the first seller bid is the winning bid; (4) upon the condition it is determined the time period for the first reverse auction or the established reverse auction has ended and the first seller bid is determined to not be the lowest bid, determining, by the one or more computers, the first seller bid is not the winning bid; (5) upon the condition it is determined the time period for the first reverse auction or the established reverse auction has not ended, maintaining, by the one or more computers, the first seller bid as part of the first reverse auction or the established reverse auction and iterating back to step (G)(2); (H) upon the condition it is determined in step (G) that the first seller bid is a winning bid, making available, by the one or more computers, to the first seller computer system, access to demand aggregate information corresponding to the first demand aggregate or the established demand aggregate so that the first demand aggregate or the established demand aggregate can be satisfied by the first seller in accordance with the first seller bid; and (I) upon the condition it is determined in step (G) that the first seller bid is not a winning bid, making available, by the one or more computers, to a seller computer system corresponding to a seller that provided the winning bid with access to demand aggregate information corresponding to the first demand aggregate or the established demand aggregate so that the first demand aggregate or the established demand aggregate can be satisfied in accordance with the winning bid.

In accordance with an exemplary embodiment, the step (D)(2) of determining a first geographical area comprising clustering the first geographical location with the at least a second geographical location by at least one of but not limited to: (i) Euclidean allocation to generate polygonal raster zones of address points; (ii) generation of Origin-Destination matrices using Thiessen proximal polygons; (iii) determining a geographical region in which the first geographical location and the at least a second geographical location are located; or (iv) any combination of two or more of (i), (ii) and (iii).

In accordance with an exemplary embodiment, the geographical region comprises a type selected from the group consisting of: state, county, town, city, municipality, province, zip-code, school district, geo political boundaries, radius map and country.

In accordance with an exemplary embodiment, the step (B) of receiving from a first purchaser computer system a first request-for-quote comprises: (1) determining, by the one or more computers, that the first purchaser is not among the plurality of purchasers; (2) sending, by the one or more computers, to the first purchaser computer system, a request for the first purchaser to register as a new purchaser; (3) receiving, by the one or more computers, from the first purchaser computer system, registration information; (4) confirming, by the one or more computers, the registration information is valid; and (5) providing, by the one or more computers, to the first purchaser computer system, a graphical user interface for input of the first request-for-quote.

In accordance with an exemplary embodiment, the step (B) of receiving from a first purchaser computer system a first request-for-quote comprises: (1) sending, by the one or more computers, to the first purchaser computer system, a request for the first purchaser to enter login credentials; (2) receiving, by the one or more computers, from the first purchaser computer system, the first purchaser login credentials; (3) verifying, by the one or more computers, the first purchaser login credentials; and (4) providing, by the one or more computers, to the first purchaser computer system, a graphical user interface for input of the first request-for-quote.

In accordance with an exemplary embodiment, the step (B) of receiving from a first purchaser computer system a first request-for-quote comprises: (1) sending, by the one or more computers, to the first purchaser computer system, a request for the first purchaser to pay a fee amount to commit to purchase the first products or service; (2) receiving, by the one or more computers, from the first purchaser computer system, the fee amount; and (3) establishing, by the one or more computers, the first purchaser as a committed purchaser.

In accordance with an exemplary embodiment, the fee amount is based on a percentage of one of the bids made during the first reverse auction or the established reverse auction.

In accordance with an exemplary embodiment, the method further comprises the step (J) of determining a total quantity of the first products and/or services corresponding to the first demand aggregate or the established demand aggregate, comprising: (1) determining, by the one or more computers, for each request-for-quote within the first demand aggregate or the established demand aggregate, a quantity of the first products and/or services; (2) calculating, by the one or more computers, a total quantity of the first products and/or services based on the determined quantities; and (3) indicating, by the one or more computers, the total quantities of the first products and/or services as part of the first reverse auction or the established reverse auction.

In accordance with an exemplary embodiment, the method further comprises the step (J) of broadcasting, by the one or more computers, the first demand aggregate or the established demand aggregate for solicitation of additional requests-for-quotes.

In accordance with an exemplary embodiment, the step (J) of broadcasting comprises publishing, by the one or more computers, the first demand aggregate or the established demand aggregate on the Internet and/or other mediums like Short message system (SMS).

In accordance with an exemplary embodiment, the step (F) of receiving a first seller bid in the first reverse auction or an established reverse auction comprises: (1) determining, by the one or more computers, that the first seller is not among the plurality of sellers; (2) sending, by the one or more computers, to the first seller computer system, a request for the first seller to register as a new seller; (3) receiving, by the one or more computers, from the first seller computer system, registration information, the registration information comprising information indicating the first seller is associated with sale of the first products or services in the first geographical area; (4) confirming, by the one or more computers, the registration information is valid; and (5) providing, by the one or more computers, to the first seller computer system, a graphical user interface for input of the first seller bid.

In accordance with an exemplary embodiment, the step (F) of receiving a first seller bid in the first reverse auction or an established reverse auction comprises: (1) sending, by the one or more computers, to the first seller computer system, a request for the first seller to enter login credentials; (2) receiving, by the one or more computers, from the first seller computer system, the first seller login credentials; (3) verifying, by the one or more computers, the first seller login credentials; and (4) providing, by the one or more computers, to the first seller computer system, a graphical user interface for input of the first seller bid.

In accordance with an exemplary embodiment, the step (F) of receiving a first seller bid in the first reverse auction or an established reverse auction comprises receiving, by the one or more computers, from the first seller computer system, a maximum deliverable quantity of products or services in satisfaction of the first demand aggregate or the established demand aggregate.

In accordance with an exemplary embodiment, the method further comprises the steps of: (1) determining, by the one or more computers, that the maximum deliverable quantity is below a threshold quantity of products or services; and (2) sending, by the one or more computers, to the first seller computer system, that the first bid is invalid.

In accordance with an exemplary embodiment, the method further comprises the steps of: (1) determining, by the one or more computers, that the maximum deliverable quantity is less than a total quantity corresponding to the first demand aggregate or the established demand aggregate; (2) determining in step (G) that the first seller bid is a winning bid; and (3) selecting, by the one or more computers, another bid as a second winning bid so that the maximum deliverable quantity provided by the first seller and a seller corresponding to the second winning bid can be combined to meet the total quantity corresponding to the first demand aggregate or the established demand aggregate.

In accordance with an exemplary embodiment, the method further comprises the steps of: (1) determining, by the one or more computers, that the maximum deliverable quantity is less than a total quantity corresponding to the first demand aggregate or the established demand aggregate; (2) determining in step (G) that the first seller bid is a winning bid; and (3) establishing, by the one or more computers, a secondary reverse auction so that the maximum deliverable quantity provided by the first seller and a winning seller of the secondary reverse auction can be combined to meet the total quantity corresponding to the first demand aggregate or the established demand aggregate.

### BRIEF DESCRIPTION OF THE DRAWINGS

The features and advantages of the disclosure can be more fully understood with reference to the following description of the disclosure when taken in conjunction with the accompanying figures, wherein:

FIG. 1 is a block diagram of a computer system for location-based aggregation of purchaser demand and reverse bidding by sellers in response to the aggregated demand in accordance with an exemplary embodiment of the present invention.

FIG. 2 is a block diagram of a computing environment in which the system of FIG. 1 may operate in accordance with exemplary embodiments of the invention.

FIG. 3 is a block diagram of a computer system for location-based aggregation of purchaser demand and reverse bidding by sellers in response to the aggregated demand in accordance with an exemplary embodiment of the present invention.

FIG. 4 is a block diagram of a computer system for location-based aggregation of purchaser demand and reverse bidding by sellers in response to the aggregated demand in accordance with an exemplary embodiment of the present invention.

FIG. 5A is a flowchart of a process for location-based aggregation of purchaser demand and reverse bidding by sellers in response to the aggregated demand in accordance with an exemplary embodiment of the present invention.

FIG. 5B is a continuation of the flowchart of FIG. 5A.

FIG. 6 is a flowchart of a process for conducting a reverse auction according to an exemplary embodiment of the present invention.

FIG. 7 are flow charts demonstrating the distinctions between forward auctions and reverse auctions.

FIG. 8 is a flowchart of a purchaser login process according to an exemplary embodiment of the present invention.

FIG. 9 is an illustration of a page of a graphical user interface for entry of new purchaser registration information in accordance with an exemplary embodiment of the present invention.

FIG. 10 is a flowchart of a process for purchaser login and purchaser RFQ processing according to an exemplary embodiment of the present invention.

FIG. 11 is an illustration of a page of a graphical user interface provided for entry of (Request-for-Quote) RFQ information according to an exemplary embodiment of the present invention.

FIG. 12 is a flowchart of a process for processing RFQs according to an exemplary embodiment of the present invention.

FIG. 13 is a flowchart of a process for seller login and bid placement according to an exemplary embodiment of the present invention.

FIG. 14 illustrates a seller dashboard according to an exemplary embodiment of the present invention.

FIG. 15 is an illustration of a page of a graphical user interface for entry of new seller registration information in accordance with an exemplary embodiment of the present invention.

FIG. 16 is a flowchart of a process for determining whether a seller is a qualified seller according to an exemplary embodiment of the present invention.

FIG. 17 is a flowchart of a process for seller login and placement of bids on a reverse auction according to an exemplary embodiment of the present invention.

FIG. 18 is a flowchart of a process for seller login and placement of automatic bids on a reverse auction according to an exemplary embodiment of the present invention.

### DETAILED DESCRIPTION

In exemplary embodiments, the present invention provides an Internet (or other network) based demand pooling/aggregating system for individual customers (also known as “purchasers”) within a specified common geographical location/area and common time-period and offering the pooled/aggregate demand to potential sellers via a reverse-auction process to secure the product(s) and/or service(s) at the lowest price possible.

More specifically, the present invention addresses the technological challenges associated with coordinating multiple purchasers having intent to purchase/take delivery of/consume the same products and/or services within a common geographical area within a common time period from multiple sellers that offer the same products and/or services within the common geographical area within the common time period. For example, from the purchaser's perspective, there is a significant computer processing burden involved in gathering information from other purchasers and processing such information to arrive at an aggregated demand, particularly if such demand is to be limited to a specific geographical location/area and time period. From the seller's perspective, there is a significant computer processing burden involved in gathering information regarding aggregated demand and communicating with multiple purchasers within a geographical area so that the aggregated demand may be fulfilled by the seller. Even more processing burden would be required for purchasers to enhance their purchasing power by pooling their demand and offering multiple sellers an opportunity to compete for the aggregated demand and for sellers to competitively offer products and/or services to fulfill the aggregated demand, particularly where there are large numbers of potential purchasers in a large number of geographical areas that all may be placing demands at many different times. To date, there are no computer-implemented systems and methods for accomplishing these objectives.

Accordingly, the present invention provides a technological solution in the form of a computer system that operates as an exchange between purchaser computer systems and seller computer systems in a manner that allows for efficient and effective pooling/aggregating of purchaser demand to arrive at a demand aggregate for products and/or services within a common geographical area and within a common time period and which also provides an efficient and effective platform that allows sellers to compete for the resultant demand aggregate. The inventive computer system alleviates the heavy processing burden on seller and purchaser computer systems that otherwise would occur to accomplish these objectives. In embodiments, the present invention provides individual consumers/purchasers within a geographically bound area the capability to pool their purchase request/demand for a product(s)/service(s) by using an Internet based platform and then using proposed server-systems comprising of server-side computing devices and algorithms to generate an aggregate of their demand. Purchasers are able to commit to their individual demand by paying and/or by agreeing to pay a commitment-fee thereby expressing non-frivolous intent to purchase the product(s)/service(s) they requested. The pool of committed demand, henceforth known as a demand-aggregate contract may be offered by way of a reverse-auction process to seller(s) who are able to deliver/provide requested product(s)/service(s) within the geographical area where purchasers have requested delivery of the same.

Since purchasers have committed their intent to purchase/take delivery of the product(s)/service(s), it incentivizes the seller(s) to participate in the reverse-auction and compete for the business opportunity of the demand-aggregate contract.

Sellers/providers may be deemed eligible sellers upon confirmation they are able to deliver requested product(s)/service(s) in the quantity/close to the quantity captured in the demand-aggregate to purchasers in the geographical area where the purchase will be delivered/consumed and are registered sellers on the computer system. Eligible seller(s) can then compete for the business of the demand-aggregate contract during the auction period by bidding for the same, with the lowest bid winning the business of the demand-aggregate contract. This enables the individual purchasers to secure the best value for their money, similar to if they were executing a bulk purchase order for the desired product(s)/service(s).

Furthermore, since the committed demand is localized to a specific geographically bound area it allows the seller(s) to plan and ship accurate inventory stock levels required to fulfill the sales generated by the demand-aggregate contract achieving optimal deployment of capital and inventory resulting in improved bottom-lines.

In embodiments, the present invention provides for one or more of the following:

1. Anchoring the initiating demand made by a purchaser for product(s) and/or service(s) (referred to hereinafter as a “seed demand”) to a geographical location/area related to the point of consumption and/or delivery of the said product(s) and/or service(s) within a defined time frame.

2. Generating a systemic construct of an aggregate demand by anchoring matching demand (matching product(s) and/or service(s), occurring within the same geographical area/point of consumption and delivery time-frame) to the seed demand by getting purchasers to commit their demand by obtaining payment details and/or obtaining payment towards a commitment fee.

3. Offering such a systemic construct of (committed) aggregate demand to qualified sellers through a reverse auction process to determine the best price and fulfillment.

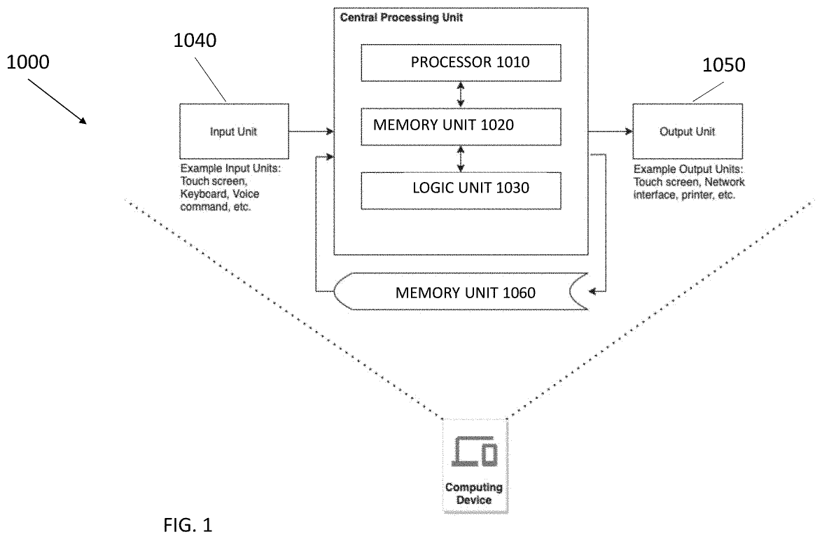

FIG. 1 is a block diagram of a computer system, generally designed by reference number 1000, for location-based aggregation of purchaser demand and reverse bidding by sellers in response to the aggregated demand in accordance with an exemplary embodiment of the present invention. The computer system 1000 may include one or more processors 1010, a memory unit 1020, a logic unit 1030, and a communication portal (e.g., for sending and/or receiving data) including an input unit 1040 and an output unit 1050. In embodiments, the computer system 1000 may include a plurality of computers in direct communication with one another and/or arranged within one or more computer networks.

The one or more processors 1010 may include one or more processing devices such as, for example, a microprocessor, a microcontroller, an application-specific integrated circuit (ASIC), a field programmable gate array (FPGA) or other type of processing circuitry, as well as portions or combinations of such circuitry elements.

The memory unit 1020 may include a non-transitory computer-readable memory with one or more databases and data stored thereon. The memory unit 1020 may comprise electronic memories such as random-access memory (RAM), read-only memory (ROM), or other types of memory, in any combination. The computer system 1000 may include a second memory unit 1060, which may include a non-transitory computer-readable memory with one or more databases and data stored thereon, and/or which may comprise electronic memories such as random-access memory (RAM), read-only memory (ROM), or other types of memory, in any combination. Data stored on the first and/or second memory units 1050, 1060 can include, for example, seller account information, purchaser account information, request-for-quote (RFQ) information, aggregate demand information, aggregate demand contract information, and reverse auction information, to name a few. As explained in further detail below, such information may include geo-tagged purchaser information associated with purchasers that have expressed an intent to purchase, consume and/or take delivery of common products and/or services within a common geographical area within a common time-period, resulting in generation of a demand aggregate for those products and/or services and an associated demand aggregate contract. The information may further include bid information associated with bids received from seller computer systems in an associated reverse auction. One or more software modules may be stored in the first and/or second memory units 1050, 1060 and running or configured to run on the one or more processors 1010. Such modules can include, for example, a buyer account module, a seller account module, an RFQ module, an aggregate demand module, an aggregate demand contract module, a bidding module, and a reverse auction module, to name a few. The processes performed by such modules, the data produced thereby and/or the data accessed thereby are described herein.

The input unit 1040 may include components, such as, for example, a touchscreen, keyboard, and voice command, to name a few. The output unit 1050 may include components, such as, for example, a touchscreen, a network interface, and a printer, to name a few.

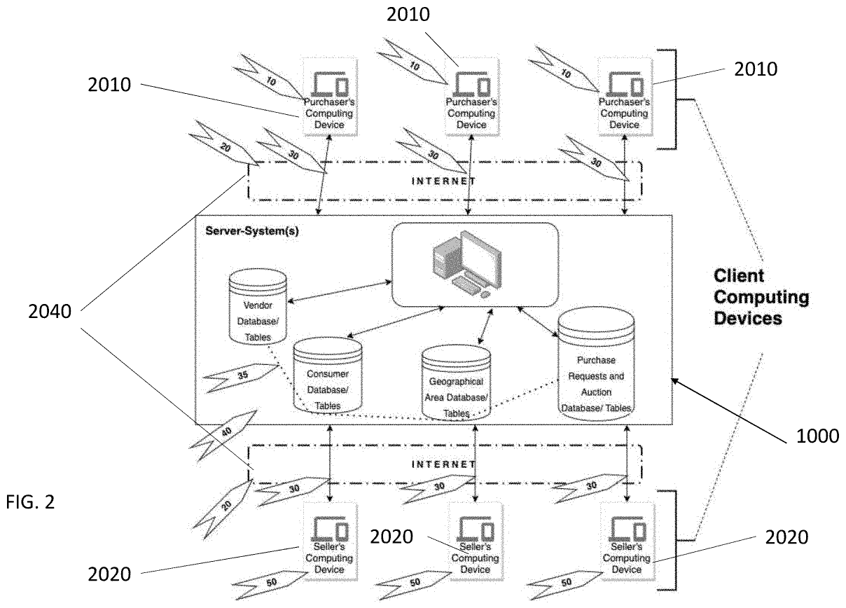

FIG. 2 is a block diagram of a computing environment in which the system 1000 may operate in accordance with exemplary embodiments of the invention. The system 1000 may be connected to a plurality of purchaser computer systems 2010 and seller computer systems 2020 either directly or over a network, such as, for example, the Internet 2040. The purchaser and seller computer systems 2010, 2020 may include any type of computing devices, such as, for example, servers, laptop computers, tablets, mobile phones, and desktop computers, to name a few.

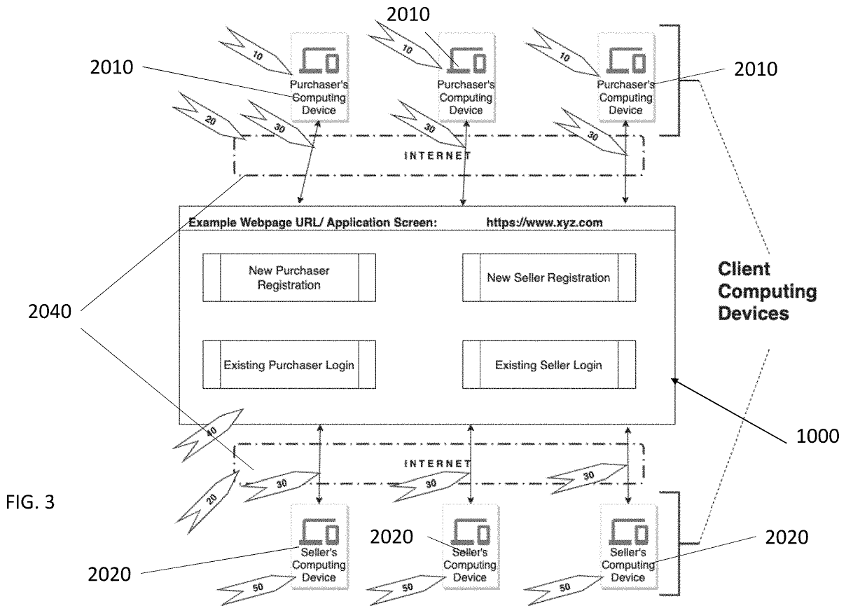

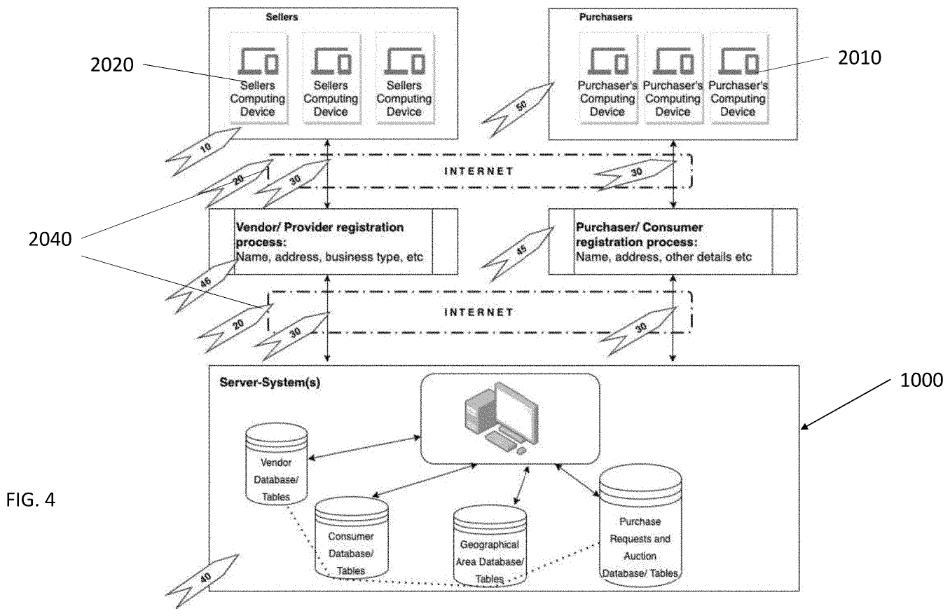

As shown in FIGS. 3 and 4, the computer system 1000 may serve various webpages to the purchaser and seller computer systems 2010, 2020. For example, as shown in FIG. 3, the computer system 1000 may provide webpage URLs and/or application screens as part of a graphical user interface that allows for new purchaser and new seller registration and purchaser and seller login. As shown in FIG. 4, the registration screens may prompt for input of information, such as, for example, name, address, business type, and other details, to name a few. The graphical user interfaces may further allow for input of other information after registration and login, as described in further detail below, such as, for example, information associated with RFQs and bids.

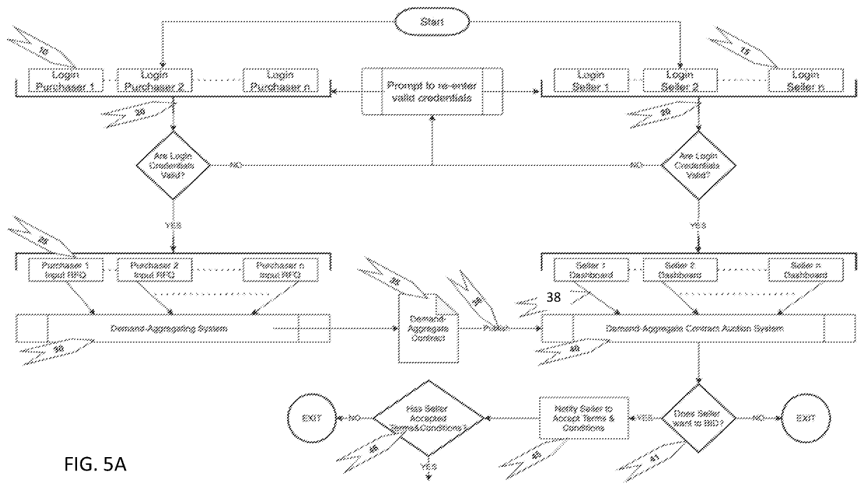

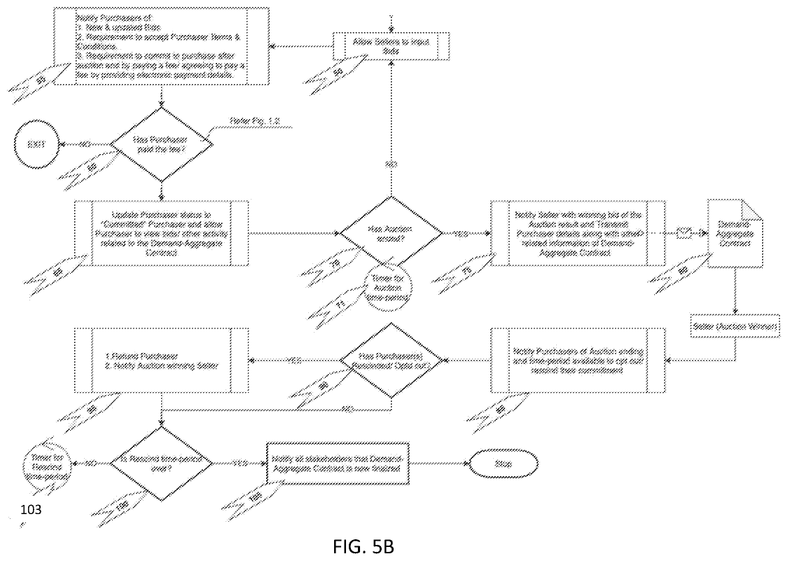

FIG. 5 is a flowchart of a process for location-based aggregation of purchaser demand and reverse bidding by sellers in response to the aggregated demand in accordance with an exemplary embodiment of the present invention. At steps 10 and 15 of the process, one or more purchasers (e.g., purchaser 1, purchaser 2, . . . purchaser n) and one or more sellers (e.g., seller 1, seller 2 . . . seller n) may be prompted to login to the system from their respective computer systems after which a determination may be made at steps 20 as to whether the login credentials are valid. If it is determined the login credentials are not valid, the system may prompt the seller or purchaser to re-enter their login credentials by, for example, sending appropriate messages to their corresponding computer systems.

At the purchaser side, if it is determined in step 20 that the login credentials are valid, at step 25, the computer system may receive request-for-quotes (RFQs) from the purchasers, where the RFQs correspond to particular products and/or services the purchasers have an intent to purchase/take delivery of/consume at a corresponding geographical location within a corresponding time period. At step 30, the RFQs may be aggregated into one or more demand aggregates, where each demand aggregate relates to a total amount of particular products and/or services to be purchased/taken delivery of/consumed within a particular geographical area and within a common time period. The total amount of products and/or services for each demand aggregate may be calculated by summing the amount of the same products and/or services requested by each purchaser within the common geographical area and within the common time period. In exemplary embodiments, purchasers may raise demand by inputting RFQs using their client computing devices to access the computer system via the Internet.

In exemplary embodiments, each demand-aggregate corresponds to a defined geographical area of consumption/delivery (“Service-Area”) to pool/combine/aggregate demand arising from a plurality of purchasers intending to execute a purchase transaction for common product(s)/service(s) and consume/accept/receive delivery of their purchase within a shared/common and/or pre-defined geographical area on or around a desired date of delivery (a common time period). In an exemplary embodiment, the computer system may calculate the relative proximity of addresses to each other based on the delivery destination of the purchase order. An example of aggregating demand delivery location/addresses includes categorizing & grouping/clustering/aggregating purchaser RFQs by area addresses and/or zip-codes and/or school districts and/or counties and/or states and/or by employing various geo-spatial tools such as, but not limited to, maps of the area, Euclidean Allocation and/or Thiessen Polygons of delivery address points.

At step 35, the computer system may generate one or more demand aggregate contracts corresponding to each demand aggregate generated in step 30. Each demand aggregate may include terms and conditions, along with information regarding the specified products and/or services, to be delivered/consumed within a defined geographical area and time period.

At step 36, the demand aggregate contracts are then published on, for example, the Internet, a private area network, and/or a local area network, to name a few. In exemplary embodiments, the creation of a demand-aggregate by the computer system will automatically be broadcast/socialized on various media by the computer system to reach other potential purchaser(s)/consumer(s) desiring to receive delivery of the same product(s)/service(s) within the same pre-defined geographical area of delivery/purchase consumption. Interested parties, including, but not limited to, purchaser/seller users, may also publish/share the demand-aggregate on various social media platforms of their choosing to drive engagement within their community and increase the business opportunity of the demand-aggregate. The socializing/sharing of the invite to join the established demand-aggregate can be manually initiated by the user(s) and/or automated by the computer system 1000.

At the seller side, if it is determined in step 20 that the login credentials are valid, prompts may be sent to the seller computer systems for the sellers to make bids in a reverse auction on the demand aggregate contracts generated in step 35. In this regard at step 38, each seller computer system may be provided with a graphical user interface (e.g., “seller 1 dashboard”, “seller 2 dashboard” . . . “seller n dashboard”) that allows the corresponding seller at step 40 to interface with a demand-aggregate auction module. If it is determined in step 41 that a seller wants to bid on a demand aggregate contract, the computer system may provide the seller with the terms and conditions of the demand aggregate contract of interest (step 45). At step 46, if the seller does not accept the terms and condition, the process for the seller will end. Otherwise, the process continues to step 50, where the computer system allows the seller to input a bid to the auction associated with the corresponding demand aggregate contract. In this regard, the auction may be termed a “reverse auction” in that the winning bid is associated with the lowest bid price, as opposed to a conventional auction where the winning bid is associated with a highest bid price.

Returning to the purchaser side, in step 55, the purchasers associated with the running reverse auction are provided with information via secure (e.g., encrypted) modes of communication through their respective purchaser computer systems, such as, for example, new and updated bids made in the reverse auction, requirement to accept purchaser terms and conditions, and requirement to commit to purchase after auction end by paying a fee/agreeing to pay a fee by providing electronic payment details. In step 60, if it is determined a purchaser has paid or committed to pay the fee, the purchaser status within the relevant demand-aggregate may be updated to “committed purchaser” which would provide the purchaser with certain benefits, such as, for example, allowing the purchaser to view bids and/or other activity related to the corresponding demand aggregate contract. Otherwise, the process for that purchaser will end.

In step 70, the computer system determines if the reverse auction has ended by, for example, iterating through a time check process (step 71) to determine whether the end time associated with the reverse auction has arrived. If it is determined the auction has ended, the process proceeds to step 75, where the computer system may transmit certain information via secure (ex. encrypted) modes of communication to the winning seller computer system, such as, for example, a winning bid notification, purchaser details, and information related to the demand aggregate contract, to name a few. In this regard, at step 80, a copy of the demand aggregate contract may be electronically transmitted via secure (ex. encrypted) modes of communication to the winning seller computer system by, for example (but not limited to), e-mail.

In step 85, the computer system may send certain information to the purchaser computer systems corresponding to the purchasers associated with the reverse auction, such as, for example, notification that the auction has ended and time-period available to opt out and/or rescind their commitment. If it is determined in step 90 that a purchaser has rescinded and/or opted out of the demand aggregate contract within the rescind time period, the process proceeds to step 95, where that purchaser may be refunded and the winning seller may be notified that the purchaser has rescinded and/or opted out of the demand aggregate. Otherwise, the process may proceed to step 100, where it is determined whether the rescind/opt-out time-period has ended by, for example, iterating through a time check process (step 103) to determine whether the end time associated with the rescind/opt out period has arrived.

If it is determined in step 100 that the rescind/opt out time period has ended, the computer system may send notifications to the purchaser computer systems associated with the remaining committed purchasers and the winning seller computer system that the demand aggregate contract associated with the reverse auction is now finalized. The process may then end.

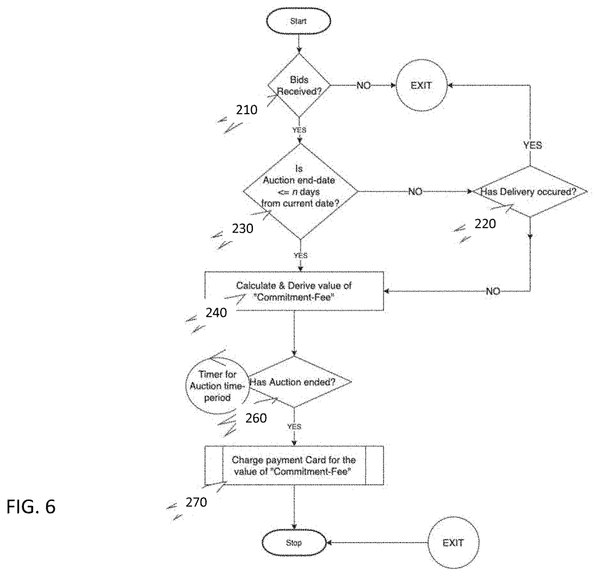

FIG. 6 is a flowchart of a process for conducting a reverse auction according to an exemplary embodiment of the present invention. After the process starts, the computer system determines in step 210 whether any bids have been received from one or more seller computer systems. If no, the process ends and may re-start on a periodic basis to determine again whether any bids have been received. In exemplary embodiments, each auction may have a defined auction time-period during which bidding will be open. During the active auction time-period sellers will be able to participate in the reverse auction and compete for the demand-aggregate's business by placing bids. The auction time-periods may be constant or vary for the demand-aggregate contracts, where the variation may depend on factors such as, for example, service(s)/product(s) and/or the desired date of delivery, to name a few. The auction time-period may be dynamically selected based on various other parameters associated with the demand-aggregate contract.

If it is determined that one or more bids have been received, the process continues to step 220, where it is determined whether the auction end-time is less than or equal to the current time. If the auction end time is not less than or equal to the current time (i.e., the auction had ended), the process continues to step 230, where it is determined whether the products or services that is the subject of the demand aggregate contract have been delivered. If delivery has occurred, the process ends. Otherwise, the process continues to step 240. If it is determined in step 220 that the auction end-time is less than or equal to the current date (i.e., the auction is still in progress), the process also continues to step 240.

At step 240 the computer system calculates the value of a commitment fee. For example, the commitment fee may be calculated as a set percentage of one of the bids, such as, for example, a first bid received during the reverse auction (which may or may not be the lowest/winning bid). At the time of paying the commitment fee, the purchaser may also sign/accept the relevant “Terms & Conditions” governing the transaction of the purchase-RFQ captured in the demand-aggregate. In embodiments, the combination of actions of paying the commitment-fee and signing/accepting the “Terms & Conditions” progresses the purchaser participant of the demand-aggregate from a member to a committed-purchaser and enables the purchaser to execute the purchase transaction at the lowest price determined by auction result of the demand-aggregate contract's reverse auction process.

In embodiments, a demand-aggregate member may be asked to pay a fee by using a payment card and/or using any credit available in their user account to confirm their purchase intent and thereby become eligible for executing a purchase at the auction winning price. This fee could be, for example, a flat fee and/or could be a percentage of the total purchase price.

Purchaser(s) who have raised RFQs are considered members of the demand-aggregate. A committed-purchaser may be defined as a demand-aggregate member who has committed their intent to purchase product(s)/service(s) by either paying or agreeing to pay a commitment fee by providing payment details such as, but not limited to, credit and/or debit cards along with authorization to charge the same. The demand-aggregate member may be requested to pay/agree to pay by way of pre-authorizing and/or authorizing their payment method for a percentage of the first bid received.

At step 260, the computer system may determine whether the reverse auction has ended by, for example, iterating through a time check process to determine whether the end time associated with the reverse auction has arrived. Once it is determined that the auction end-time has arrived, the computer system may at step 270 may process the commitment fees for each of the committed purchasers for a relevant demand-aggregate. For example, step 270 may involve electronically charging a debit or credit card associated with committed purchasers in the amount of the commitment fee. The process may then end.

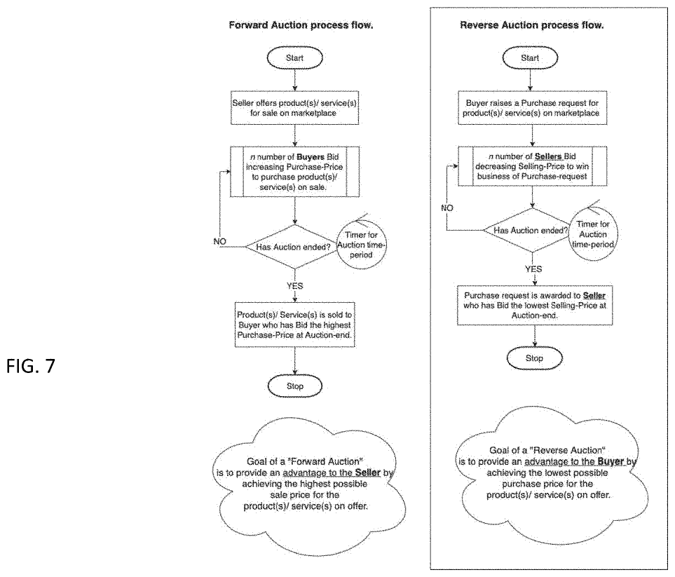

FIG. 7 are flow charts demonstrating the distinctions between forward auctions and reverse auctions. In forward auctions, purchasers place bids on products or services offered by sellers, which provides an advantage to sellers by achieving the highest possible sale price for the offered products or services. In contrast, reverse auctions in accordance with exemplary embodiments of the present invention involve sellers placing bids on products or services that are the subject of purchase requests made by purchasers, which provides purchasers with the advantage of achieving the lowest possible purchase price for the offered products and/or services.

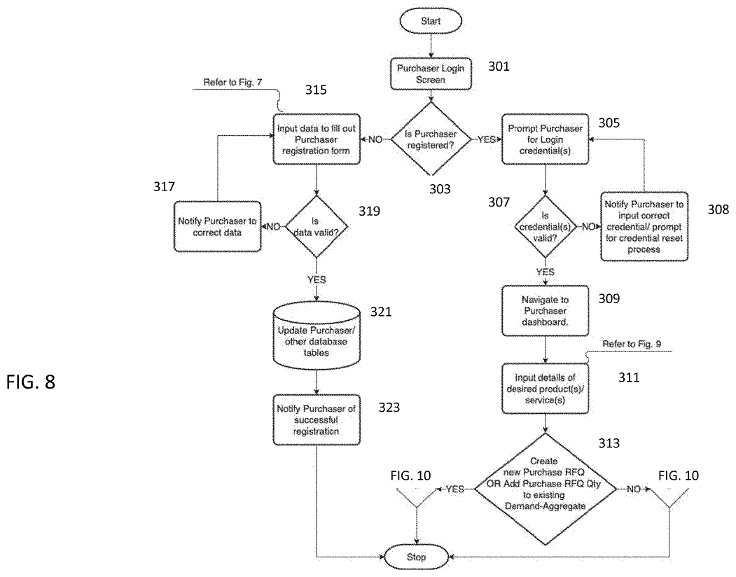

FIG. 8 is a flowchart of a purchaser login process according to an exemplary embodiment of the present invention. After the process starts, the computer system 1000 serves or otherwise makes available at step 301 a purchaser login screen at the purchaser computer system. At step 303, the computer system 1000 may determine whether the purchaser is already registered. This step may involve the purchaser sending back information to the computer system 1000 regarding the purchaser's registration status. If the purchaser is registered, the computer system 1000 may prompt the purchaser at step 305 to enter login credentials, and then the credentials may be validated at steps 307 and 308 (with iterations through those steps as many times as needed). Once the purchaser is validated, the computer system 1000 at step 309 may serve or otherwise make available a purchaser dashboard, and then at step 311 the purchaser may create an RFQ by inputting to the purchaser dashboard details of desired products or services, where the details may include items, such as, for example, type, quantity, address of where delivery of purchase is to be made, desired date-range for delivery, to name a few.

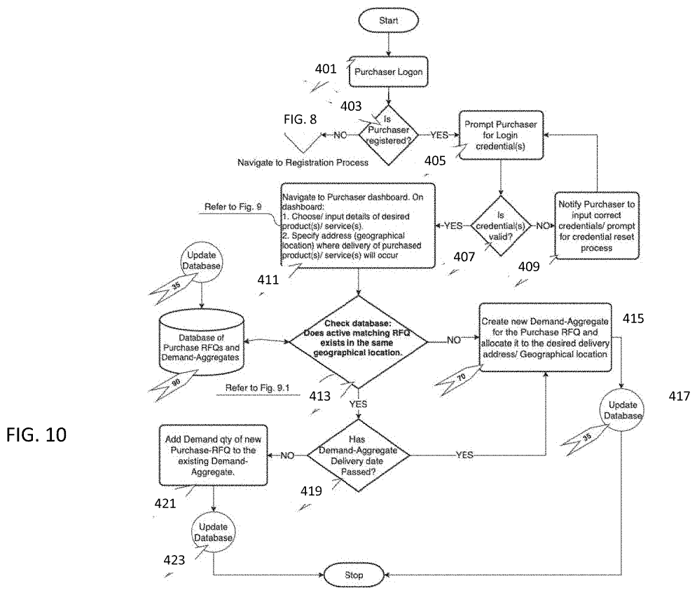

The process then continues to step 313, where the computer system 1000 may determine whether to generate a new demand aggregate based on the received RFQ or add the RFQ to an already-established demand aggregate. Details of this step are provided in FIG. 10. The process may then end.

If the computer system 1000 determines at step 303 that the purchaser is not already registered, the process may continue to step 315, where a prompt may be sent to the purchaser computer system to input registration data. The registration data may be validated by iterating through steps 317 and 319 as many times as needed. After the purchaser has been registered, the computer system 1000 may update at step 321 a purchaser account database and/or other databases with the new registration information. The purchaser may then be notified of successful registration at step 323. The process may then end.

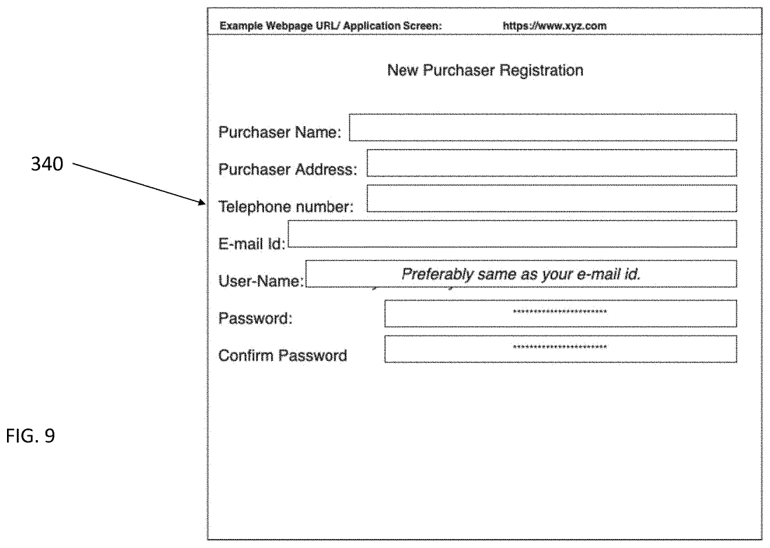

FIG. 9 is an illustration of a page, generally designated by reference number 340, of a graphical user interface provided by computer system 1000 for entry of new purchaser registration information in accordance with an exemplary embodiment of the present invention. The page 340 may include input fields, such as, for example, purchaser name, purchaser address, telephone number, e-mail address, user-name, and password, to name a few. Each field may provide drop-down menus for selection of the appropriate input or may allow for the information to be manually typed in, as necessary.

FIG. 10 is a flowchart of a process for purchaser login and purchaser RFQ processing according to an exemplary embodiment of the present invention. After the process starts, at step 401, the computer system 1000 may prompt the purchaser to login. At step 403, if it is determined the purchaser is not registered, the process may continue to steps 315 to 323 as shown in FIG. 8. Otherwise, at step 405, the computer system 1000 may prompt the purchaser to enter login credentials, and the login credentials may be validated by iterating through steps 407 and 409 as many times as needed.

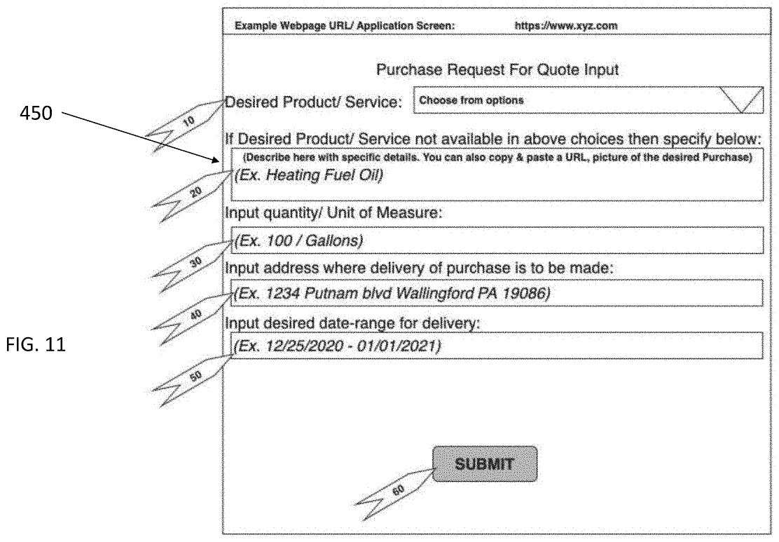

After purchaser login, at step 411, the purchaser may be provided with a purchaser dashboard, where the purchaser may select and/or input details of desired products or services and specify the address or some other geographical location where delivery of purchased products or services will occur. In this regard, FIG. 11 is an illustration of a page, generally designated by reference number 450, of a graphical user interface provided by computer system 1000 for entry of RFQ information. The page 450 may include input fields, such as, for example, desired product or service, quantity, unit of measure, address where delivery of purchase will take place, and desired date-range of delivery, to name a few. Each field may provide drop-down menus for selection of the appropriate input or may allow for the information to be manually typed in, as necessary.

After input of the RFQ, the process continues to step 413, where the computer system 1000 determines whether the RFQ matches an already established RFQ that may or may not be a part of an already established demand aggregate. In this step, the computer system 1000 may compare the received RFQ with information in a database of RFQs and demand aggregates. If it is determined that there are no matching RFQs, the process may continue to step 415, where the computer system 1000 may seed and generate a new demand aggregate for the new RFQ and allocate the new demand aggregate to the associated geographical location. The new demand aggregate may then at step 417 be added to the appropriate database(s).

If it is determined in step 413 that there is a demand aggregate with a matching RFQ, the process may continue to step 419, where the computer system 1000 determines whether the demand aggregate delivery date has passed. If so, the process goes back to step 415 to generate a new demand aggregate. Otherwise, the process continues to step 421 where the computer system 1000 adds the demand quantity of the newly received RFQ to the matching established demand aggregate. Then, at step 423, the computer system 1000 may update a demand aggregate database and/or other database(s) as appropriate. The process may then end after either steps 417 or 423.

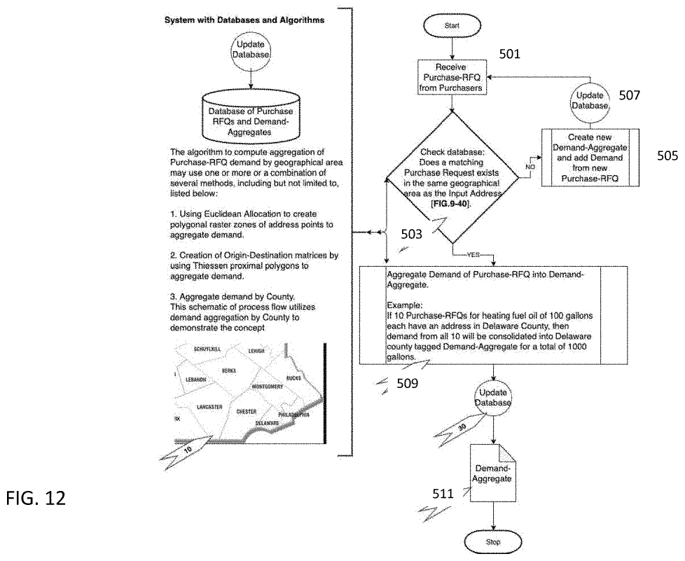

FIG. 12 is a flowchart of a process for processing RFQs according to an exemplary embodiment of the present invention. After the process starts, at step 501, the computer system 1000 received an RFQ from a purchaser computer system. Then, at step 503, the computer system 1000 may determine whether there is a matching purchase request and/or demand aggregate in the same geographical area as the input address. If no, the process continues to step 505, where a new demand aggregate may be generated and the demand from the new RFQ may be added to the newly generated demand aggregate. At step 507, the demand aggregate database is updated with the newly generated demand aggregate.

The algorithm for calculation of aggregation of RFQ demand by geographical area may use one or more (but not limited to) of a combination of several techniques, such as, for example, Euclidean Allocation to create polygonal raster zones of address points to aggregate demand, creation of Origin-Destination matrices by using Thiessen proximal polygons to aggregate demand, and aggregation of demand by county or some other geographic area, to name a few.

If it is determined in step 503 that there is a matching purchase request and/or demand aggregate, the demand of the received RFQ may be added to the matching purchase request and/or demand aggregate. At step 509, the demand aggregate database may be updated by taking into account the added demand. At step 511, at some time before the delivery date associated with the updated demand aggregate, a final demand aggregate for that corresponding geographical area and corresponding time period may be generated that will be the subject of a reverse auction.

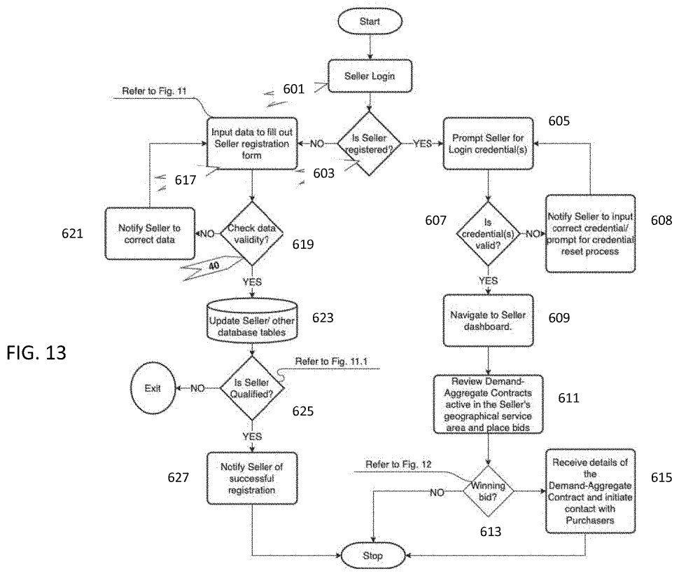

FIG. 13 is a flowchart of a process for seller login and bid placement according to an exemplary embodiment of the present invention. After the process starts, at step 601, the computer system 1000 sends a prompt to the seller computer system for the seller to login. In this step, the computer system 1000 may serve or otherwise makes available a seller login screen at the seller computer system. At step 603, the computer system 1000 may determine whether the seller is already registered. This step may involve the seller sending back information to the computer system 1000 regarding the seller's registration status. If the seller is registered, the computer system 1000 may prompt the seller at step 605 to enter login credentials, and then the credentials may be validated at steps 607 and 608 (with iterations through those steps as many times as needed).

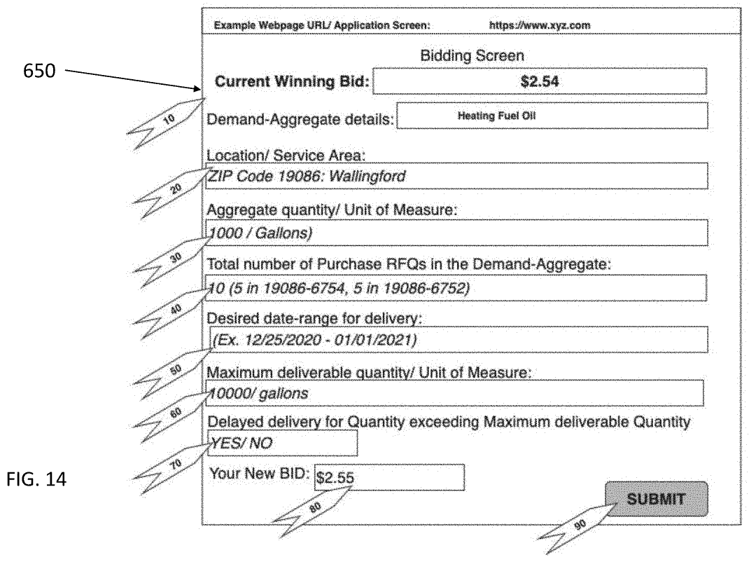

Once the purchaser is validated, the computer system 1000 at step 609 may serve or otherwise make available a seller dashboard at the seller computer system to allow the seller to place a bid in a reverse auction of interest. In embodiments, in step 611, the seller dashboard allows the seller to review demand-aggregate contracts active in the seller's geographical area (of service) and place bids in reverse auctions associated with those demand-aggregate contracts. In this regard, FIG. 14 illustrates a seller dashboard, generally designated as reference number 650, according to an exemplary embodiment of the present invention. The seller dashboard 650 may include fields, such as, for example, current winning bid, demand-aggregate details, location and/or service area, aggregate quantity, unit of measure, total number of RFQs in the demand aggregate, and desired date range for delivery, to name a few. The seller dashboard 650 may also include seller input fields, such as, for example, a maximum deliverable quantity that the seller can provide, an indication as to whether the seller is willing to provide delayed delivery on any amount exceeding the maximum deliverable quantity (e.g., by placing the excess amount on backorder), and a new bid amount, to name a few. Each field may provide drop-down menus for selection of the appropriate input or may allow for the information to be manually typed in, as necessary.

At step 613, the computer system 1000 determines whether the bid received from the seller computer system is a winning bid. If so, the process continues to step 615 where the computer system 1000 provides to the seller computer system the details of the demand aggregate contract so that the seller can initiate contact with the purchasers associated with the demand aggregate contract. Otherwise, the process may end.

If it is determined in step 603 that the seller is not registered, the process may continue to step 617, where a prompt may be sent to the seller computer system to input registration data. The registration data may be validated by iterating through steps 619 and 621 as many times as needed. After the seller has been registered, the computer system 1000 may update at step 623 a seller account database and/or other databases with the new registration information.

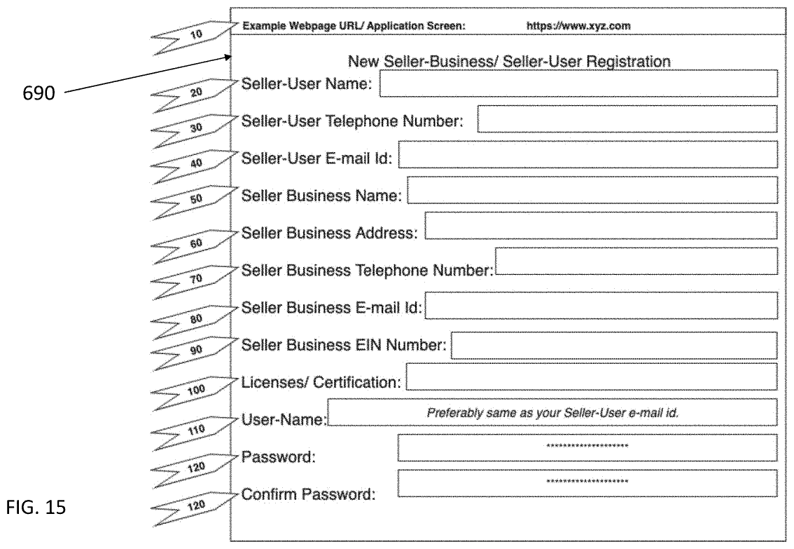

FIG. 15 is an illustration of a page, generally designated by reference number 690, of a graphical user interface provided by computer system 1000 for entry of new seller registration information in accordance with an exemplary embodiment of the present invention. The page 690 may include input fields, such as, for example, seller name, seller telephone number, seller email address, seller business name, seller business address, seller telephone number, seller business email address, seller business EIN number, licenses and/or certifications, user name, password, and confirm password, to name a few. Each field may provide drop-down menus for selection of the appropriate input or may allow for the information to be manually typed in, as necessary.

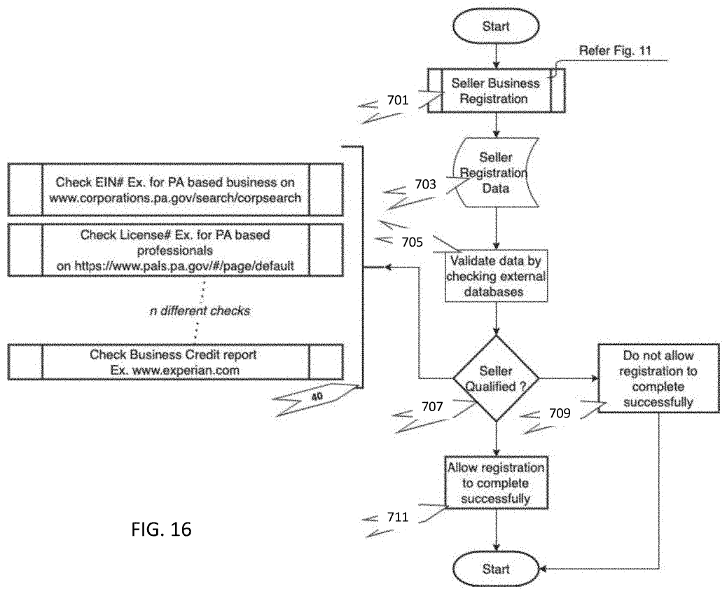

At step 625, the computer system may determine if the seller is a qualified seller. In this regard, FIG. 16 is a flowchart of process for determining whether a seller is a qualified seller according to an exemplary embodiment of the present invention. In step 701 of the process, the computer system 1000 receives from the seller computer system a completed electronic seller registration form, and in step 703 the computer system 1000 extracts seller registration data from the completed seller registration form. In step 705, the computer system 1000 may validate the extracted data by checking data sources, such as, for example, external databases to determine whether the seller is a qualified seller (step 707). In this regard, the computer system 1000 may use the extracted data to reference data sources, such as, for example, government sites (e.g., to verify EIN and license number), credit reporting sites, and business review sites, to name a few.

If it is determined that the seller is not a qualified seller, in step 709 the computer system 1000 may not allow the seller to successfully register, at which point the process may end. Otherwise, in step 711, the computer system 1000 may allow the registration to complete successfully. In either case, the computer system 1000 may send a notification to the seller computer system indicating the registration status as being successful or unsuccessful.

Returning to FIG. 13, if it is determined in step 625 that the seller is a qualified seller, the seller may be notified accordingly at step 627, and then the process may end. Otherwise, the seller may be notified that registration failed and the process may end.

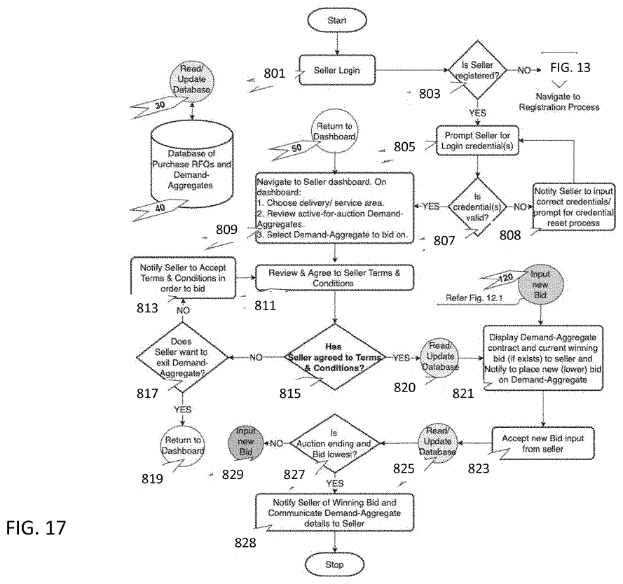

FIG. 17 is a flowchart of a process for seller login and placement of bids on a reverse auction according to an exemplary embodiment of the present invention. After the process starts, at step 801, the computer system 1000 sends a prompt to the seller computer system for the seller to login. In this step, the computer system 1000 may serve or otherwise makes available a seller login screen at the seller computer system. At step 803, the computer system 1000 may determine whether the seller is already registered. This step may involve the computer system receiving back from the seller computer system information regarding the seller's registration status. If the seller is registered, the computer system 1000 may prompt the seller at step 805 to enter login credentials, and then the credentials may be validated at steps 807 and 808 (with iterations through those steps as many times as needed).

Once the purchaser is validated, the computer system 1000 at step 809 may serve or otherwise make available a seller dashboard at the seller computer. In embodiments, the computer system 1000 may receive back selections from the seller computer system regarding a desired delivery/service area and a demand aggregate contract on which the seller would like to place bids. At step 811, the computer system 1000 may send to the seller computer system terms and conditions associated with the seller-selected demand aggregate contract for the seller to review along with a prompt at step 813 for the seller to accept the terms and conditions.

At step 815, the computer system 1000 determines whether the seller has accepted the terms and conditions. This step may involve the computer system 1000 receiving from the seller computer system an indication that the seller has accepted or rejected the terms and conditions. If it is determined the seller has rejected the terms and conditions, the process may continue to step 817, where the computer system 1000 may determine whether the seller wishes to discard the demand aggregate contract by, for example, sending a request to the seller computer system for the seller to confirm either continued interest or no further interest in the demand aggregate contract. If it is determined the seller is no longer interested, the process may continue to step 819, where the computer system 1000 again serves or otherwise makes available the seller dashboard on the seller computer system so the seller can potentially make another selection.

If it is determined in step 815 the seller has accepted the terms and conditions, the computer system 1000 may at step 820 updates the demand aggregate database and/or other databases as necessary with information indicating the seller is an eligible seller for that particular demand aggregate contract. The process then continues to step 821 where the computer system 1000 may serve or otherwise make available a seller dashboard (such as the seller dashboard 650 described above) for display of the demand aggregate contract, display of the current winning bid (if there is one) and prompting of the seller to place a new bid on the demand aggregate contract. At step 823, the computer system 1000 may accept the new bid from the seller, associate it with the relevant demand aggregate contract in the database and at step 825 update an auction database and other databases as appropriate with the new bid information.

At step 827, the computer system 1000 may determine whether the auction has ended. If so, the computer system 1000 may send information to the seller computer system regarding the winning bid along with details regarding the demand aggregate contract that was the subject of the reverse auction. In this step, if the seller entered the winning bid, the computer system 1000 may send a notification to the seller computer system that the seller made the winning bid and may proceed with satisfaction of the demand aggregate contract. The process may then end. If it is determined that the auction has not yet ended, the process may continue at step 829 with acceptance of further new bids.

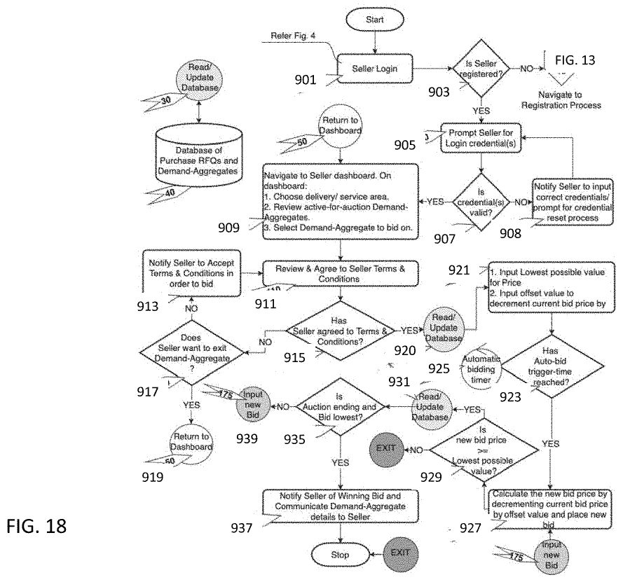

FIG. 18 is a flowchart of a process for seller login and placement of automatic bids on a reverse auction according to an exemplary embodiment of the present invention. After the process starts, at step 901, the computer system 1000 sends a prompt to the seller computer system for the seller to login. In this step, the computer system 1000 may serve or otherwise makes available a seller login screen at the seller computer system. At step 903, the computer system 1000 may determine whether the seller is already registered. This step may involve the computer system receiving back from the seller computer system information regarding the seller's registration status. If the seller is registered, the computer system 1000 may prompt the seller at step 905 to enter login credentials, and then the credentials may be validated at steps 907 and 908 (with iterations through those steps as many times as needed).

Once the purchaser is validated, the computer system 1000 at step 909 may serve or otherwise make available a seller dashboard at the seller computer. In embodiments, the computer system 1000 may receive back selections from the seller computer system regarding a desired delivery/service area and a demand aggregate contract on which the seller would like to place bids. At step 911, the computer system 1000 may send to the seller computer system terms and conditions associated with the seller-selected demand aggregate contract for the seller to review along with a prompt at step 913 for the seller to accept the terms and conditions.

At step 915, the computer system 1000 determines whether the seller has accepted the terms and conditions. This step may involve the computer system 1000 receiving from the seller computer system an indication that the seller has accepted or rejected the terms and conditions. If it is determined the seller has rejected the terms and conditions, the process may continue to step 917, where the computer system 1000 may determine whether the seller wishes to discard the demand aggregate contract by, for example, sending a request to the seller computer system for the seller to confirm either continued interest or no further interest in the demand aggregate contract. If it is determined the seller is no longer interested, the process may continue to step 919, where the computer system 1000 again serves or otherwise makes available the seller dashboard on the seller computer system so the seller can potentially make another selection.

If it is determined in step 915 the seller has accepted the terms and conditions, the computer system 1000 may update the demand aggregate database and/or other databases as necessary with information indicating the seller is an eligible seller for that particular demand aggregate contract. The process then continues to step 921 where the computer system 1000 may serve or otherwise make available a seller dashboard for display of the demand aggregate contract, display of the current winning bid (if there is one) and prompting of the seller to place a new bid on the demand aggregate contract. The seller dashboard may allow the seller to set an automated bid process by allowing for input of a minimum value for the lowest offered bid price along with an offset value by which to decrease the current lowest bid price in the auction for generation of a new bid from the seller. For example, the seller may choose to place automatic bids that are $5.00 less than the current lowest bid until some minimum bid amount is reached (e.g., a minimum bid amount of $25). This process allows the seller to place a series of decreasing bid prices during the auction but with a limit to the lowest possible bid price to be offered by the seller.

At step 923, the computer system 1000 may determine whether an automatic bid trigger-time has arrived by iterating through a timer check (step 925). At each trigger-time, the process may continue to step 927, where the computer system 1000 may calculate the seller's new bid price by decreasing the current lowest bid price by the preset offset value. Then, at step 929, the computer system 1000 may determine whether the new bid price is greater than the seller's lowest possible bid price. If not, the process may end. Otherwise, the computer system 1000 may accept the new bid from the seller and at step 931 update an auction database and other databases as appropriate with the new bid information.

At step 935, the computer system 1000 may determine whether the auction has ended. If so, the computer system 1000 may send at step 937 information to the seller computer system regarding the winning bid along with details regarding the demand aggregate contract that was the subject of the reverse auction. In this step, if the seller entered the winning bid, the computer system 1000 may send a notification to the seller computer system that the seller made the winning bid and may proceed with satisfaction of the demand aggregate contract. The process may then end. If it is determined that the auction has not yet ended, the process may continue at step 939 with acceptance of further new bids.

In embodiments, an eligible seller may input a maximum deliverable quantity based on the desired date(s) of delivery in the demand-aggregate contract. The eligible seller may also indicate that ordered quantity exceeding the maximum deliverable quantity would be accepted and considered as back-ordered and delivered (possibly) later than the desired date of delivery. In this regard, the computer system 1000 may propose/place limits on the value that is valid for input for maximum deliverable quantity and restrict the seller from being able to place bids amongst other restrictions if the maximum deliverable quantity for a demand-aggregate-contract is less than a predetermined value. The computer system 1000 may utilize the maximum deliverable quantity, delayed delivery indicator, total quantity in the demand-aggregate contract, demand by geographical area and/or a combination thereof to potentially trigger subsequent activities, such as, for example, split the demand-aggregate contract and to further offer the newly split demand-aggregate contract for a new auction, to name two.

In embodiments, in the event that there are no seller bids and/or a threshold number of purchasers that have committed-to-pay/have paid the commitment-fee has not been reached and/or a threshold number of purchasers choose to rescind their commitment during the rescind-time period, the demand-aggregate contract may be deemed as inconclusive and dissolved. Purchasers that have paid the commitment fee may then be refunded.

The following examples illustrate further details and advantages in accordance with exemplary embodiments of the present invention. In these examples, the Server-system may be the computer system 1000 as described previously.

Example 1: Using zip codes to represent the geographical area of delivery/purchase consumption to aggregate purchase demand for products:
1. Purchaser-1 inputs a Request-for-Quote(RFQ) for 100 gallons of “Heating fuel oil” to be delivered at an address having zip code 19086 with a requested delivery date of (Today+X) days.
2. The Server-system programmatically determines that zip code 19086 is in Delaware County, PA.
3. The Server-system considers this as the initiating RFQ and creates a Demand-aggregate with the (not limited to) following entries:
   Heating fuel oil+(Today+X)+19086+Delaware County+PA|Purchaser details|100|Gallons
   At this moment in time there is only one RFQ in the Demand-aggregate. The consolidated/aggregate quantity is 100 gallons.
4. Purchaser-2 and Purchaser-3 subsequently input their RFQs for 250 gallons each of “Heating fuel oil” to be delivered at addresses having zip code 19063 with a requested delivery date of (Today+X)+1.
5. Purchaser-4 and Purchaser-5 subsequently input additional RFQs for 150 gallons each of “Heating fuel oil” to be delivered at addresses having zip code 19086 with a requested delivery date of (Today+X)−1.
6. The Server-system programmatically determines that zip code 19063 is in Delaware County, PA as well and updates the Demand-aggregate entries created in step 3 as follows:
   Heating fuel oil+[(Today+X)]+19086+Delaware County+PA|Purchaser-1 details|100|Gallons
   Heating fuel oil+[(Today+X)+1]+19063+Delaware County+PA|Purchaser-2 details|250|Gallons
   Heating fuel oil+[(Today+X)+1]+19063+Delaware County+PA|Purchaser-3 details|250|Gallons
   Heating fuel oil+[(Today+X)−1]+19086+Delaware County+PA|Purchaser-4 details|150|Gallons
   Heating fuel oil+[(Today+X)−1]+19086+Delaware County+PA|Purchaser-5 details|150|Gallons
   Now there are 5 RFQs in the Demand-aggregate. The consolidated/aggregate quantity for Delaware County captured in the Demand-aggregate is 900 gallons. The aggregate quantity can further be sub-categorized by additional parameters such as, but not limited to, requested delivery date and/or zip code(s):
   Aggregate demand for “requested delivery date[(Today+X)+1]+19063” is 500 gallons
   Aggregate demand for “requested delivery date[(Today+X)−1]+19086” is 300 gallons
   Aggregate demand for “requested delivery date[(Today+X)]+19086” is 100 gallons

Example 2: Using airport codes to represent geographical area of delivery/purchase consumption & desired travel dates to aggregate purchase demand for airline tickets:
1. Purchaser-1 inputs a Request-for-Quote(REQ) for 4 return tickets to fly from PHL (Philadelphia) to MCO(Orlando) with a requested travel start date of X day and return date of 6 day.
2. The Server-system considers this as the initiating RFQ and creates a Demand-aggregate with the following rows:
   Airline Ticket+X+δ+PHL+MCO|Purchaser-1 details|4|Tickets
   At this moment in time there is a one RFQ in the Demand-aggregate. The consolidated/aggregate quantity is 4 tickets.
7. Purchaser-2 thru Purchaser-10 subsequently input their RFQs for 5 return tickets each to fly from PHL (Philadelphia) to MCO(Orlando) with a requested travel start date of X day and return date of δ day.
8. Purchaser-11 thru Purchaser-15 subsequently input their RFQs for 1 return tickets each to fly from PHL (Philadelphia) to MCO(Orlando) with a requested travel start date of X day and return date of δ day.
9. After receiving each RFQ, the Server-system determines the matching Demand-aggregate created in step 2 and incrementally updates it as follows:
   Airline Ticket+X+δ+PHL+MCO|Purchaser-1 details|4|Tickets
   Airline Ticket+X+δ+PHL+MCO|Purchaser-2 details|5|Tickets
   Airline Ticket+X+δ+PHL+MCO|Purchaser-3 details|5|Tickets
   Airline Ticket+X+δ+PHL+MCO|Purchaser-4 details|5|Tickets
   Airline Ticket+X+δ+PHL+MCO|Purchaser-5 details|5|Tickets
   Airline Ticket+X+δ+PHL+MCO|Purchaser-6 details|5|Tickets
   Airline Ticket+X+δ+PHL+MCO|Purchaser-7 details|5|Tickets
   Airline Ticket+X+δ+PHL+MCO|Purchaser-8 details|5|Tickets
   Airline Ticket+X+δ+PHL+MCO|Purchaser-9 details|5|Tickets
   Airline Ticket+X+δ+PHL+MCO|Purchaser-10 details|5|Tickets
   Airline Ticket+X+δ+PHL+MCO|Purchaser-11 details|1|Tickets
   Airline Ticket+X+δ+PHL+MCO|Purchaser-12 details|1|Tickets
   Airline Ticket+X+δ+PHL+MCO|Purchaser-13 details|1|Tickets
   Airline Ticket+X+δ+PHL+MCO|Purchaser-14 details|1|Tickets
   Airline Ticket+X+δ+PHL+MCO|Purchaser-15 details|1|Tickets

Now there are 15 individual RFQs in the Demand-aggregate. The consolidated/aggregate quantity for the request for airline tickets to fly a return trip from PHL to MCO captured in the Demand-aggregate is 54 tickets.

Considering examples 1 & 2 for illustration of the “invite” concept discussed in preceding paragraphs: An invite to join, including a URL link of, the demand-aggregate(s) could be composed to share & convey details of the demand-aggregate as below and socialized/broadcast to engage potential purchasers—
Example 1: Heating fuel oil+[(Today+X)]+19086+Delaware County+PA|
Example 2: Airline Ticket+X+δ+PHL+MCO|

Considering example 1 for a non-limiting illustration of how a demand-aggregate member becomes a Committed-Purchaser. If a seller bids on the demand-aggregate to supply heating oil at $2/gallon then Purchaser-1 will commit to purchase $200 ($2/gallon*100 gallons) worth of heating-oil in order to commit their Purchase-demand. In this case, if the commitment-fee for “Heating oil” is set at 10% then Purchaser-1 would be requested to pay/agree to pay by way of pre-authorizing their payment for $20 (10% of $200). If threshold number of Purchasers commit to their Purchase-demand then the total commitment-fee collected/authorized would be $180 (900 gallons*$2/gallon=$1800. 10% of $1800=$180).

Considering example 2 for a non-limiting illustration of how a demand-aggregate member becomes a Committed-Purchaser. If a seller bids on the demand-aggregate to provide airline-tickets for the return trip from Philadelphia to Orlando & back at $100 then the Purchaser-1 will commit to purchase $400 ($100/ticket*4 return tickets) worth of tickets. In this case, if the commitment-fee for “Airline-tickets” is set at 50% then Purchaser-1 would be requested to pay/agree to pay by way of pre-authorizing their payment method for $200 (50% of $400) in order to commit their Purchase-demand for airline-tickets.

Considering examples 1 & 2 for a non-limiting conceptual illustration of the effect a value in the “maximum deliverable quantity” field [FIGS. 9.2-60] has on the demand-aggregate contract's auction process as discussed in preceding paragraphs: After the eligible Seller indicates acceptance of ‘Terms & Conditions’ relevant to the demand-aggregate contract, the Server-System will allow the eligible Seller to navigate to the ‘Auction’ functional area/screen to place bids. In the ‘Auction’ functional area/screen, certain text or value input fields will be mandatory. If the text or value input field maximum deliverable quantity is mandatory, then the Server-system based on the product(s)/service(s) may choose to calculate & enforce a minimum threshold value for the field as below:

Demand-aggregate Example 1: Heating fuel oil+[(Today+X)]+19086+Delaware County+PA|

Aggregate demand (total) quantity of Heating fuel oil in the Demand-aggregate is 900 gallons. The Server-system may calculate the minimum value valid for maximum deliverable quantity as 810 gallons (900*(90/100)). In order for an eligible seller to be able to bid for the business of the demand-aggregate contract the value in the maximum deliverable quantity cannot be less than 810 gallons or 90% of the aggregate demand quantity.

Considering examples 1 & 2 for a non-limiting conceptual illustration of the auction of a demand-aggregate as discussed in preceding paragraphs: Upon creation/emergence of a demand-aggregate, an invitation to bid is broadcast to eligible sellers. Interested eligible sellers can then bid for the consolidated business opportunity of the demand-aggregate. Since, this is a Reverse-auction, the bids cannot be higher than the current bid. Before an eligible seller may place a bid, the seller will accept the Terms & Conditions governing the demand-aggregate contract.

Demand-aggregate Example 1: Heating fuel oil+[(Today+X)]+19086+Delaware County+PA
Seller-1 places bid of $2.00/gallon
Seller-2 places bid of $1.99/gallon
Seller-3 places bid of $1.90/gallon
Seller-4 places bid of $1.89/gallon
Seller-1 places bid of $1.85/gallon
Seller-2 places bid of $1.80/gallon
Seller-1 places bid of $1.80/gallon
Seller-3 places bid of $1.75/gallon
Seller-1 places bid of $1.74/gallon (auction time period ends)

At the end of the auction time-period the winning bid is $1.74/gallon of “heating fuel oil”. The demand-aggregate contract business opportunity of 900 gallons of “heating fuel oil” is awarded to Seller-1 who has placed the winning-bid of $1.74/gallon. The value of the demand-aggregate gained by seller-1 is $1566 ($1.74/gallon*900 gallons).

Demand-aggregate Example 2: Airline Ticket+X+δ+PHL+MCO
Seller-1 places bid of $115.00/ticket
Seller-2 places bid of $100.00/ticket
Seller-3 places bid of $95.00/ticket
Seller-4 places bid of $90.00/ticket
Seller-1 places bid of $88.00/ticket
Seller-2 places bid of $85.00/ticket
Seller-1 places bid of $75.00/ticket
Seller-3 places bid of $70.00/ticket
Seller-1 places bid of $65.00/ticket (auction time-period ends)

At the end of the auction time-period the winning bid is $65/ticket of “Airline Ticket+X+δ+PHL+MCO|”. The demand-aggregate contract business opportunity of 54 tickets of “Airline Ticket+X+δ+PHL+MCO|” is awarded to Seller-1 who has placed the winning-bid of $65/ticket. The value of the demand-aggregate gained by Seller-1 is $3510 ($65/ticket*54 tickets).

In the case of Example 1 (this is a non-limiting example to illustrate the concept), the balance amount (total cost of purchase minus commitment-fee) will be paid directly to the Seller by the Purchaser upon delivery of purchased product(s)/service(s) which is Heating fuel-oil in this case.

In the case of Example 2 (this is a non-limiting example to illustrate the concept), the balance amount (total cost of purchase minus commitment-fee) will be collected by the server-system and a voucher/voucher code will be provided to the Purchaser. The Purchaser may use this voucher/voucher code and redeem it for the actual ticket from the Seller. Payment due to the seller for the product(s)/service(s), tickets in this case, will be paid by the server-system to the seller after the rescind time period has passed.

A percentage of the purchase transaction in both examples will be retained by the server-system as commission/fee for facilitating the transaction using the systems & methods enjoined in this invention.

While the above description contains many specifics, these should not be construed as limitations on the scope of the application, but rather as exemplification of preferred embodiments. Numerous other variations of the present application are possible, and it is not intended herein to mention all of the possible equivalent forms or ramifications of this application.

What is claimed is:

1. A method comprising:
(A) accessing, by one or more computers, one or more electronic databases stored on one or more computer-readable media, comprising:
(1) purchaser account information for a plurality of purchaser accounts corresponding to a plurality of purchasers of products or services;
(2) request-for-quote information for a plurality of request-for-quotes each made by a corresponding purchaser among the plurality of purchasers for purchase of a corresponding quantity of corresponding products or services within a corresponding geographical area within a corresponding time period;
(3) demand aggregate information for a plurality of demand aggregates, each demand aggregate corresponding to two or more request-for-quotes made by corresponding two or more purchasers from among the plurality of purchasers for common products or services within a common geographical area within a common corresponding time period, each demand aggregate further corresponding to a total quantity of the corresponding common products or services;
(4) seller account information for a plurality of seller accounts corresponding to a plurality of sellers of products or services; and
(5) reverse auction information for a plurality of reverse auctions each comprising at least one reverse bid made by at least one of the plurality of sellers in response to at least one of the plurality of demand aggregates;
(B) receiving, by the one or more computers, from a first purchaser computer system, a first request-for-quote corresponding to first products or services that a first purchaser has an intent to at least one of purchase, consume or take delivery of at a first geographical location at a first time;
(C) determining, by the one or more computers, whether the first request-for-quote corresponds to an established demand aggregate among the plurality of demand aggregates, the step of determining comprising:
(1) comparing, by the one or more computers, the first products or services, the first geographical location and the first time to the plurality of demand aggregates to determine whether at least one demand aggregate among the plurality of demand aggregates is a matching demand aggregate corresponding to products or services that match the first products or services, a geographical area in which the first geographical location is included, and a time period within which the first time is included;
(2) upon the condition it is determined that at least one demand aggregate among the plurality of demand aggregates is a matching demand aggregate, identifying, by the one or more computers, the at least one demand aggregate as the established demand aggregate; and
(3) upon the condition it is not determined that at least one demand aggregate among the plurality of demand aggregates is a matching demand aggregate, determining, by the one or more computers, that the first request-for-quote does not correspond to an established demand aggregate among the plurality of demand aggregates with corresponding products or services that match the first products or services, a geographical area in which the first geographical location is included, and a time period within which the first time is included;
(D) upon the condition it is determined in step (C) that the first request-for-quote does not correspond to an established demand aggregate among the plurality of demand aggregates, generating, by the one or more computers, a first demand aggregate as a new demand aggregate corresponding to the first request-for-quote, the step of generating comprising:
(1) receiving, by the one or more computers, from at least a second purchaser computer system, at least a second request-for-quote corresponding to the first products or services that at least a second purchaser has an interest in purchasing at a second geographical location within the first period of time;
(2) determining, by the one or more computers, a first geographical area corresponding to the first demand aggregate based on the first geographical location and the second geographical location;
(3) adding, by the one or more computers, the at least a second request-for-quote to the first demand aggregate; and
(3) generating, by the one or more computers, a first reverse auction as a new reverse auction for satisfaction of the first demand aggregate comprising the first request-for-quote and the at least a second request-for-quote;
(E) upon the condition it is determined in step (C) that the first request-for-quote does correspond to an established demand aggregate among the plurality of demand aggregates, adding, by the one or more computers, the first request-for-quote to the established demand aggregate;
(F) receiving, by the one or more computers, from a first seller computer system, a first seller bid in the first reverse auction or an established reverse auction corresponding to the established demand aggregate, the first seller bid further corresponding to a first seller for sale of the first products or services;
(G) analyzing, by the one or more computers, whether the first seller bid is a winning bid, the step of analyzing comprising:
(1) determining, by the one or more computers, whether a time period for the first reverse auction or an established reverse auction among the plurality of reverse auctions corresponding to the established demand aggregate has ended;
(2) comparing, by the one or more computers, the first seller bid to other bids within the first reverse auction or to other bids within the established reverse auction to determine whether the first seller bid is a lowest bid;
(3) upon the condition it is determined the time period for the first reverse auction or the established reverse auction has ended and the first bid is determined to be the lowest bid, determining, by the one or more computers, the first seller bid is the winning bid;
(4) upon the condition it is determined the time period for the first reverse auction or the established reverse auction has ended and the first seller bid is determined to not be the lowest bid, determining, by the one or more computers, the first seller bid is not the winning bid;
(5) upon the condition it is determined the time period for the first reverse auction or the established reverse auction has not ended, maintaining, by the one or more computers, the first seller bid as part of the first reverse auction or the established reverse auction and iterating back to step (G)(2);
(H) upon the condition it is determined in step (G) that the first seller bid is a winning bid, making available, by the one or more computers, to the first seller computer system, access to demand aggregate information corresponding to the first demand aggregate or the established demand aggregate so that the first demand aggregate or the established demand aggregate can be satisfied by the first seller in accordance with the first seller bid; and
(I) upon the condition it is determined in step (G) that the first seller bid is not a winning bid, making available, by the one or more computers, to a seller computer system corresponding to a seller that provided the winning bid with access to demand aggregate information corresponding to the first demand aggregate or the established demand aggregate so that the first demand aggregate or the established demand aggregate can be satisfied in accordance with the winning bid.

2. The method of claim 1, wherein the step (D)(2) of determining a first geographical area comprising clustering the first geographical location with the at least a second geographical location by at least one of:
(i) Euclidean allocation to generate polygonal raster zones of address points;
(ii) generation of Origin-Destination matrices using Thiessen proximal polygons;
(iii) determining a geographical region in which the first geographical location and the at least a second geographical location are located; or
(iv) any combination of two or more of (i), (ii) and (iii).

3. The method of claim 2, wherein the geographical region comprises a type selected from the group consisting of: state, county, town, city, municipality, province, zip-code, school district, geo political boundaries, radius map and country.

4. The method of claim 1, wherein the step (B) of receiving from a first purchaser computer system a first request-for-quote comprises:
(1) determining, by the one or more computers, that the first purchaser is not among the plurality of purchasers;
(2) sending, by the one or more computers, to the first purchaser computer system, a request for the first purchaser to register as a new purchaser;
(3) receiving, by the one or more computers, from the first purchaser computer system, registration information;
(4) confirming, by the one or more computers, the registration information is valid; and
(5) providing, by the one or more computers, to the first purchaser computer system, a graphical user interface for input of the first request-for-quote.

5. The method of claim 1, wherein the step (B) of receiving from a first purchaser computer system a first request-for-quote comprises:
(1) sending, by the one or more computers, to the first purchaser computer system, a request for the first purchaser to enter login credentials;
(2) receiving, by the one or more computers, from the first purchaser computer system, the first purchaser login credentials;
(3) verifying, by the one or more computers, the first purchaser login credentials; and
(4) providing, by the one or more computers, to the first purchaser computer system, a graphical user interface for input of the first request-for-quote.

6. The method of claim 1, wherein the step (B) of receiving from a first purchaser computer system a first request-for-quote comprises:
(1) sending, by the one or more computers, to the first purchaser computer system, a request for the first purchaser to pay a fee amount to commit to purchase the first product or service;
(2) receiving, by the one or more computers, from the first purchaser computer system, the fee amount; and
(3) establishing, by the one or more computers, the first purchaser as a committed purchaser.

7. The method of claim 6, wherein the fee amount is based on a percentage of one of the bids made during the first reverse auction or the established reverse auction.

8. The method of claim 1, further comprising the step (J) of determining a total quantity of the first product or service corresponding to the first demand aggregate or the established demand aggregate, comprising:
(1) determining, by the one or more computers, for each request-for-quote within the first demand aggregate or the established demand aggregate, a quantity of the first product or service;
(2) calculating, by the one or more computers, a total quantity of the first product or service based on the determined quantities; and
(3) indicating, by the one or more computers, the total quantity of the first product or service as part of the first reverse auction or the established reverse auction.

9. The method of claim 1, further comprising the step (J) of broadcasting, by the one or more computers, the first demand aggregate or the established demand aggregate for solicitation of additional requests-for-quotes.

10. The method of claim 9, wherein the step (J) of broadcasting comprises publishing, by the one or more computers, the first demand aggregate or the established demand aggregate on the Internet.

11. The method of claim 1, wherein the step (F) of receiving a first seller bid in the first reverse auction or an established reverse auction comprises:
(1) determining, by the one or more computers, that the first seller is not among the plurality of sellers;
(2) sending, by the one or more computers, to the first seller computer system, a request for the first seller to register as a new seller;
(3) receiving, by the one or more computers, from the first seller computer system, registration information, the registration information comprising information indicating the first seller is associated with sale of the first products or services in the first geographical area;
(4) confirming, by the one or more computers, the registration information is valid; and
(5) providing, by the one or more computers, to the first seller computer system, a graphical user interface for input of the first seller bid.

12. The method of claim 1, wherein the step (F) of receiving a first seller bid in the first reverse auction or an established reverse auction comprises:
(1) sending, by the one or more computers, to the first seller computer system, a request for the first seller to enter login credentials;
(2) receiving, by the one or more computers, from the first seller computer system, the first seller login credentials;
(3) verifying, by the one or more computers, the first seller login credentials; and
(4) providing, by the one or more computers, to the first seller computer system, a graphical user interface for input of the first seller bid.

13. The method of claim 1, wherein the step (F) of receiving a first seller bid in the first reverse auction or an established reverse auction comprises receiving, by the one or more computers, from the first seller computer system, a maximum deliverable quantity of products or services in satisfaction of the first demand aggregate or the established demand aggregate.

14. The method of claim 13, further comprising the steps of:
(1) determining, by the one or more computers, that the maximum deliverable quantity is below a threshold quantity of products or services; and
(2) sending, by the one or more computers, to the first seller computer system, that the first bid is invalid.

15. The method of claim 13, further comprising the steps of:
(1) determining, by the one or more computers, that the maximum deliverable quantity is less than a total quantity corresponding to the first demand aggregate or the established demand aggregate;
(2) determining in step (G) that the first seller bid is a winning bid; and
(3) selecting, by the one or more computers, another bid as a second winning bid so that the maximum deliverable quantity provided by the first seller and a seller corresponding to the second winning bid can be combined to meet the total quantity corresponding to the first demand aggregate or the established demand aggregate.

16. The method of claim 13, further comprising the steps of:
(1) determining, by the one or more computers, that the maximum deliverable quantity is less than a total quantity corresponding to the first demand aggregate or the established demand aggregate;
(2) determining in step (G) that the first seller bid is a winning bid; and
(3) establishing, by the one or more computers, a secondary reverse auction so that the maximum deliverable quantity provided by the first seller and a winning seller of the secondary reverse auction can be combined to meet the total quantity corresponding to the first demand aggregate or the established demand aggregate.
